(19) United States
(12) Patent Application Publication
(10) Pub. No.: US 2010/0237262 A1
(43) Pub. Date: Sep. 23, 2010

(54) ELECTRON BEAM WRITING METHOD AND APPARATUS

(75) Inventors: Toshihiro USA, Odawara-shi (JP); Kenji SUGIYAMA, Odawara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/724,856

(22) Filed: Mar. 16, 2010

(30) Foreign Application Priority Data
Mar. 18, 2009 (JP) 2009-065596

(51) Int. Cl. G21K 5/00

(52) U.S. Cl. 250/492.3

(57) ABSTRACT

When performing pattern writing by emitting an electron beam, a fixed frequency component, which is a component of a variation in an encoder signal from the encoder in one rotation of the rotation stage that commonly appears in a plurality of different rotational speeds of the rotation stage, is compensated for by deflection correcting the electron beam in a circumferential direction, and a variable frequency component, which is a component of the variation in the encoder signal other than the fixed frequency component, is compensated for by changing the clock frequency of a write clock.

### BACKGROUND OF THE INVENTION

1. Field of the Invention

The present invention relates to an electron beam writing method and apparatus for writing a desired fine pattern when manufacturing a master, such as an imprint mold, a magnetic transfer master carrier, or the like, for a high density magnetic recording medium, such as a discrete track medium, a bit pattern medium, or the like.

The invention also relates to a method for manufacturing an uneven pattern carrier, such as an imprint mold, a magnetic transfer master carrier, and the like, having an uneven pattern surface formed by the electron beam writing method described above. The invention further relates to a method for manufacturing a magnetic disk medium having an uneven pattern transferred thereto from the uneven pattern carrier or imprint mold, and a method for manufacturing a magnetic disk medium having a magnetized pattern transferred thereto from the magnetic transfer master carrier.

2. Description of the Related Art

Generally, information patterns, such as servo patterns and the like are formed in advance on current magnetic disk media. In view of the demand of higher recording density, a discrete track medium (DTM) in which magnetic interference between adjacent data tracks is reduced by separating the tracks with a groove pattern (guard band) has been attracting wide attention. A bit pattern medium (BPM) proposed for achieving still higher density is a medium in which magnetic substances forming single magnetic domains (single-domain particles) are physically isolated and disposed regularly, and one bit is recorded in one particle.

Heretofore, fine patterns, such as servo patterns and the like, have been formed on magnetic media as uneven patterns, magnetic patterns, or the like and an electron beam writing method for patterning a predetermined fine pattern on a magnetic transfer master carrier or the like has been proposed. In the electron beam writing method, a master is placed on a rotation stage and while rotating the master by rotating the rotation stage, a pattern is written on the master by deflection scanning an electron beam on the master as described, for example, in U.S. Pat. No. 7,026,098.

In the electron beam writing, a method in which a pattern is written by synchronizing an encoder signal from an encoder that detects a rotational angle position of a drive motor for driving the rotation stage and a writing clock generated in a pattern generator (formatter) is generally used. Therefore, if the rotational speed of the drive motor for driving the rotation stage varies, an error occurs in the arrangement of a pattern in a circumferential direction.

The encoder that detects a rotational angle position of the spindle motor is a device that optically or magnetically detects passing of multiple slits provided radially and equiangularly on a disk attached to the rotating shaft of the motor, and a scale error may occur due to variations in the angle and shape of the slits, or decentering when the disk is attached.

Japanese Unexamined Patent Publication Nos. 2002-050084 and 2008-140419 propose a method in which a write clock PLL circuit for synchronizing a write clock signal serving as the reference of exposure timing with an encoder signal and a deflection means for deflecting the electron beam in a rotational direction (circumferential direction) based on a phase error signal of the PLL circuit are provided in order to correct a positional shift in a circumferential direction due to a phase error by deflecting the electron beam. Further, Japanese Unexamined Patent Publication No. 2008-203555 proposes a method for correcting rotational variation by correcting the frequency of the write clock based on an error component obtained by subtracting a scale error from a phase error signal.

Any of the methods for correcting rotational variation described in Japanese Unexamined Patent Publication Nos. 2002-050084, 2008-140419, and 2008-203555 is a method for deflecting the beam and/or correcting the write clock frequency based on the data of rotational variation measured in advance.

However, the inventors of the present invention have found that the rotational variation at the time of writing often differs from the rotational variation measured in advance and that the methods described in Japanese Unexamined Patent Publication Nos. 2002-050084, 2008-140419, and 2008-203555 can not provide satisfactory pattern arrangement accuracy.

The present invention has been developed in view of the circumstances described above, and it is an object of the present invention to provide an electron beam writing apparatus and writing method capable of improving pattern arrangement accuracy in a circumferential direction.

It is a further object of the present invention to provide a method for manufacturing an uneven pattern carrier, such as an imprint mold, an magnetic transfer master carrier, and the like, using the electron beam writing method described above, and a method for manufacturing a magnetic disk medium having an uneven pattern or a magnetic pattern transferred thereto using the uneven pattern carrier.

### SUMMARY OF THE INVENTION

An electron beam writing method of the present invention is a method that performs pattern writing on a master placed on a rotation stage having an encoder and rotated by the rotation stage by emitting an electron beam to the master based on a predetermined write clock, wherein, when performing the pattern writing, a fixed frequency component, which is a component of a variation in an encoder signal from the encoder in one rotation of the rotation stage that commonly appears in a plurality of different rotational speeds of the rotation stage, is compensated for by deflection correcting the electron beam in a circumferential direction, and a variable frequency component, which is a component of the variation in the encoder signal other than the fixed frequency component, is compensated for by changing the clock frequency of the write clock.

The term “a variation in an encoder signal” as used herein refers to a variation in intervals between rising edges of the encoder signal (encoder pulse). The term “a fixed frequency component that commonly appears in a plurality of different rotational speeds” as used herein refers to a frequency component that commonly appears in similar spectral patterns when the frequency component of variation of the encoder signal is measured in each rotation of the plurality of different rotational speeds. Here, the term “similar spectral patterns” refers to spectral patterns that correspond to each other within ±10% of an average intensity value in the plurality of rotations. In the mean time, the term “a variable frequency component” as used herein refers to a component which reappears in the same rotational speed but varies in different rotational speeds.

Preferably, the compensation for the fixed frequency component is performed by obtaining and storing the fixed frequency component in advance by measuring a variation in the encoder signal in one rotation of the rotation stage a plurality of times by changing the rotation speed of the rotation stage, performing a frequency analysis on each variation in the encoder signal, and extracting the fixed frequency component from frequency components of the variation in the encoder signal; and when performing the pattern writing, deflection correcting the electron beam in the circumferential direction with respect to each predetermined radial position of the master based on the fixed frequency component in one rotation of the rotation stage.

Preferably, the compensation for the variable frequency component is performed by obtaining and storing the fixed frequency component in advance by measuring a variation in the encoder signal in one rotation of the rotation stage a plurality of times by changing the rotation speed of the rotation stage, performing a frequency analysis on each variation in the encoder signal, and extracting the fixed frequency component from frequency components of the variation in the encoder signal; extracting the variable frequency component by measuring a variation in the encoder signal from the encoder in one rotation of the rotation stage at each predetermined radial position of the master, performing a frequency analysis on the variation in the encoder signal, and subtracting the fixed frequency component from the variation; and changing the clock frequency of the write clock for writing in one rotation of the rotation stage at a next predetermined radial position of the master after the predetermined radial position based on the variable frequency component.

Preferably, when writing a magnetic disk pattern having servo patterns disposed regularly in the circumferential direction as the pattern described above, the variation of the encoder signal is compensated for with respect to each start position of the servo patterns in each round of the rotation stage.

An electron beam writing apparatus of the present invention is an apparatus that performs pattern writing on a master placed on a rotation stage having an encoder and rotated by the rotation stage by emitting an electron beam to the master based on a predetermined write clock, the apparatus including:

a variation measurement means for measuring a variation in an encoder signal from the encoder in one rotation of the rotation stage;

a frequency analysis means for performing a frequency analysis on the variation in the encoder signal measured by the variation measurement means;

a deflection correction means for deflection correcting the electron beam in a circumferential direction such that a fixed frequency component, which is a component of the variation in the encoder signal that commonly appears in a plurality of different rotational speeds, is compensated for; and

a clock frequency correction means for changing the clock frequency of the write clock such that a variable frequency component, which is a component of the variation in the encoder signal other than the fixed frequency component, is compensated for.

Preferably, the electron beam writing apparatus of the present invention further includes a storage means for storing the fixed frequency component of frequency components of the variation in the encoder signal measured in advance by the variation measurement means and frequency analyzed by the frequency analysis means; and when the pattern writing is performed, the deflection correction means deflection corrects the electron beam in the circumferential direction with respect to each predetermined radial position of the master based on the fixed frequency component in one rotation of the rotation stage.

Preferably, the electron beam writing apparatus of the present invention further includes a storage means for storing the fixed frequency component of frequency components of the variation in the encoder signal measured in advance by the variation measurement means and frequency analyzed by the frequency analysis means, the variation measurement means is a means that measures a variation in the encoder signal from the encoder in one rotation of the rotation stage with respect to each predetermined radial position of the master, the frequency analysis means is a means that performs a frequency analysis on the variation in the encoder signal, and the clock frequency correction means is a means that extracts the variable frequency component by subtracting the fixed frequency component from the variation, and changes the clock frequency of the write clock for writing in one rotation of the rotation stage at a next predetermined radial position after the predetermined radial position based on the variable frequency component.

An uneven pattern carrier manufacturing method of the present invention is a method including the steps of:

writing a desired fine pattern on a master by the electron beam writing method of the present invention described above; and

forming an uneven pattern corresponding to the desired fine pattern using the master.

The term “an uneven pattern carrier” as used herein refers to a carrier having a desired uneven pattern on a surface, such as an imprint mold for transferring the uneven pattern to a transfer-receiving medium, a magnetic transfer master carrier for transferring a magnetic pattern according to the uneven pattern shape to a transfer-receiving medium, or the like.

A magnetic disk medium manufacturing method of the present invention is a method that uses an imprint mold which is an uneven pattern carrier, manufactured by the uneven pattern carrier manufacturing method described above, to transfer an uneven pattern corresponding to the uneven pattern provided on a surface of the imprint mold. Specific examples of magnetic disk media manufactured by the method include a discrete track medium, a bit pattern medium, and the like.

Another magnetic disk medium manufacturing method of the present invention is a method that uses a magnetic transfer master carrier which is an uneven pattern carrier, manufactured by the uneven pattern carrier manufacturing method described above, to magnetically transfer a magnetic pattern corresponding to the uneven pattern provided on a surface of the master carrier.

According to the electron beam writing method and apparatus of the present invention, when performing the pattern writing, a fixed frequency component, which is a component of a variation in an encoder signal from the encoder in one rotation of the rotation stage that commonly appears in a plurality of different rotational speeds of the rotation stage, is compensated for by deflection correcting the electron beam in a circumferential direction, and a variable frequency component, which is a component of the variation in the encoder signal other than the fixed frequency component, is compensated for by changing the clock frequency of the write clock. This may improve pattern arrangement accuracy in a circumferential direction regardless of manufacturing accuracy, such as angular and shape variations of the encoder slits, scale errors, such as decentering when the disk is attached, variations in the rotational speed of the drive motor that drives the rotation stage.

According to the uneven pattern carrier manufacturing method of the present invention, the method includes the step of exposing a desired fine pattern on a substrate applied with a resist by the electron beam writing method described above and forming an uneven pattern thereon corresponding to the desired fine pattern. Thus, a substrate having thereon a highly accurate uneven pattern may be obtained easily. In particular, in the case of an imprint mold, when performing shape patterning using imprint technology, the fine pattern may be transferred to the surface of the medium at a time by pressing the imprint mold onto the surface of a resin layer serving as a mask in the process of forming a magnetic disk medium, whereby magnetic disk medium having excellent properties, such as a discrete track medium, a bit pattern medium, or the like may be manufactured easily. In the case of a magnetic transfer master carrier, the carrier has, on a surface, a fine pattern of a magnetic layer having at least a servo pattern, so that a magnetic recording medium having excellent properties may be manufactured easily by bringing the master carrier into contact with the magnetic recording medium and applying a magnetic field thereto using magnetic transfer technology, and transfer forming a magnetic pattern corresponding to the pattern of the magnetic layer of the master carrier on the magnetic recording medium.

### BRIEF DESCRIPTION OF THE DRAWINGS

FIG. 1 is a schematic configuration diagram of an electron beam writing apparatus according to an embodiment of the present invention.

FIG. 2 schematically illustrates write start timings when encoder pulse does not have any variation.

FIG. 3 schematically illustrates write start timings when encoder pulse variation is corrected by deflection.

FIG. 4 schematically illustrates write start timings when encoder pulse variation is corrected by changing the write clock frequency.

FIG. 5 is a plan view of an example of hard disk pattern to be written on a substrate by the electron beam writing method of the present invention.

FIG. 6 is a partially enlarged view of the hard disk pattern.

FIG. 7 schematically illustrates, in an enlarged manner, a basic writing principle for writing elements of a fine pattern A and various signals B to G used in the basic writing principle shown in A.

FIG. 8 is a partially enlarged view of a fine pattern of a discrete track medium.

FIG. 9 is a schematic cross-sectional view, illustrating a process of transfer forming a fine pattern using an imprint mold having a fine pattern written by the electron beam writing method or fine pattern writing system.

FIG. 10A to FIG. 10C are schematic cross-sectional views, illustrating a process of transfer forming a magnetic pattern using a magnetic transfer master having a fine pattern written by the electron beam writing method or fine pattern writing system.

### DESCRIPTION OF THE PREFERRED EMBODIMENTS

Hereinafter, embodiments of the present invention will be described in detail with reference to the accompanying drawings.

### <Electron Beam Writing Apparatus>

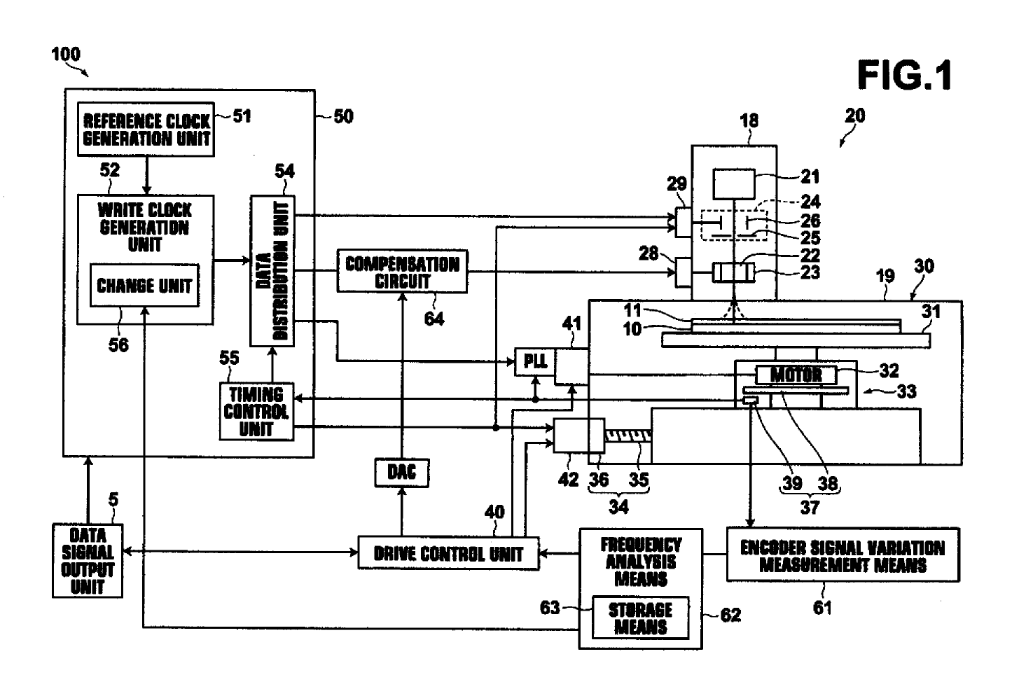

First, an embodiment of an electron beam writing apparatus for implementing an electron beam writing method according to an embodiment of the present invention will be described. FIG. 1 is a schematic configuration diagram of the electron beam writing apparatus. Electron beam writing apparatus 100 includes an electron beam emission unit 20 for emitting an electron beam onto a master, drive unit 30 for rotationally and linearly moving the master, drive control unit 40 for mechanically drive controlling the drive unit 30, formatter 50 for generating a write clock signal and outputting operation timing signals for electron beam emission unit 20 and drive unit 30, and data signal output unit 5 for outputting design data of a pattern to be written to formatter 50. Electron beam writing apparatus 100 further includes a compensation means for measuring encoder signal variation and compensating for the variation.

Electron beam emission unit 20 includes, in lens barrel 18, electron gun 21 for emitting electron beam EB, deflection means 22, 23 for deflecting electron beam EB in radial direction Y and circumferential direction X, and microscopically vibrating electron beam EB back and forth in circumferential direction X at a constant amplitude, and aperture 25 and blanking 26 (deflector) as blanking means 24 for turning ON/OFF the emission of electron beam EB. Electron beam EB outputted from electron gun 21 is emitted onto a master (here, substrate 10 applied with resist 11) through deflection means 22, 23, a not shown electromagnetic lens, and the like.

Aperture 25 of blanking means 24 has a through hole in the center for passing electron beam EB, and blanking 26 operates according to input of ON/OFF signals, in which it passes electron beam EB through the through hole of aperture 25 during OFF-signal without deflecting the beam, while it blocks electron beam. EB with aperture 25 by deflecting the beam so as not to pass through the through hole during ON-signal, so that electron beam EB is not emitted.

Drive unit 30 includes, inside housing 19 having lens barrel 18 on the upper surface, rotation stage unit 33 having rotation stage 31 for supporting a master and spindle motor 32 having a motor axis aligned with central axis of rotation stage 31, and linear moving means 34 for linearly moving rotation stage unit 33 in a radial direction of rotation stage 31. Linear moving means 34 includes rod 35 having accurate threading screwed to a portion of rotation stage unit 33 and pulse motor 36 for rotationally driving rod 35 in forward and backward directions. Rotation stage unit 33 further includes encoder 37 that outputs an encoder signal according to the rotation angle of rotation stage 31. Encoder 37 includes rotation disk 38 having multiple radial slits and attached to the motor axis of spindle motor 32 and optical device 39 for optically reading the slits and outputting an encoder signal. Note that the encoder signal may vary randomly in drive unit 30 due to a rotational velocity variation of motor 32, a shape error of the multiple slits provided in the rotation disk 38, an attachment error when the disk is attached to the drive axis, and the like.

Drive control unit 40 sends drive control signals to driver 41 of spindle motor 32 and driver 42 of pulse motor 36 in drive unit 30 for controlling the driving of the motors.

Formatter 50 includes reference clock generation unit 51 for generating a constant reference clock, write clock generation unit for generating a write clock, data distribution unit 54 for sending a data signal to deflection amplifier 28 for deflection means 22, 23 and blanking amplifier 29 for blanking 26 of electron beam emission unit 20, and a PLL circuit connected to driver 41 of the spindle motor based on the write clock, and timing control unit 55 for controlling operation timing (data distribution timing) by receiving a signal from encoder 37.

Write clock generation unit 52 includes change unit 56 for changing the frequency of the write clock according to the radial position of the master. Change unit 56 changes the frequency of the write clock at one radial position in one rotation in response to a frequency correction signal sent from frequency analysis means 62 to be described later.

The compensation means for compensating for variation in the encoder signal includes variation measurement means 61 for measuring a variation in the encoder signal in one rotation of rotation stage 31, frequency analysis means 62 for analyzing the frequency of the variation in the encoder signal measured by variation measurement means 61, deflection compensation circuit 64, as deflection compensation means, for deflection correcting the electron beam in a circumferential direction such that a fixed frequency component of the variation in the encoder signal that commonly appears in a plurality of rotations each rotated at a different rotational speed is compensated, and frequency change unit 56 in the formatter that constitutes a clock frequency correction means for changing the frequency of the write clock such that a variable frequency component other than the fixed frequency component of the variation in the encoder signal is compensated.

For example, variation measurement means 61 may be constituted by a timing interval analyzer (TIA) which measures a time interval between rise edges of the encoder signal (encoder pulse). This means that a variation in the time interval between rise edges of the pulse, that is, a deviation from the pulse rise time when the pulse is generated at a regular interval, is measured.

Frequency analysis means 62 performs frequency decomposition on a variation in the encoder signal obtained in one rotation to obtain a spectrum in each order, thereby extracting a fixed frequency component of the variation in the encoder signal, which is stored in storage means 63 provided in frequency analysis means 62.

Data signal output unit 5 has write design data (representing a write pattern or write timing) of a desired pattern, such as a hard disk pattern and the like, and outputs a write design data signal to formatter 50.

In electron beam writing apparatus 100, a write design data signal is inputted to formatter 50 from data signal output unit 5, and formatter 50 distributes the write design data as control signals, such as blanking ON/OFF control, X-Y deflection control of electron beam EB, rotational speed control of rotation stage 31, to each amplifier and driver. Each control signal is outputted at predetermined timing in synchronization with an encoder signal inputted from encoder 37. Blanking means 24, deflection means 22, 23, the spindle motor, and the like are driven based on the signal outputted from formatter 50, whereby a desired fine pattern is written over the entire surface of the master.

### <Electron Beam Writing Method>

First, a variation in the encoder signal and a compensation method therefor will be described. As described above, a variation may possibly occur in the encoder signal due to a rotational velocity variation of motor 32, a shape error of the multiple slits provided in the rotation disk 38, an attachment error when the disk is attached to the drive axis, and the like. Consequently, in the electron beam writing method of the present invention, in order to compensate for a pattern arrangement error in a circumferential direction due to the variation when writing a pattern, a fixed frequency component of a variation in the encoder signal generated in one rotation of rotation stage 31 commonly appearing in a plurality of rotations each rotated at a different rotational speed is compensated for by deflection correcting electron beam EB in the circumferential direction, and a variable frequency component other than the fixed frequency component of the variation in the encoder signal is compensated for by changing the frequency of the write clock.

More specifically, a variation in the encoder signal from encoder 37 in one rotation of rotation stage 31 is measured by encoder signal variation measurement means 61 plurality of times by changing the rotational speed of the rotation stage prior to actually writing a pattern. That is, a variation in the encoder signal in one rotation of rotation stage 31 at each of a plurality (two or more) of different rotational speeds is measured. Then, a frequency analysis is performed, for example, by Fourier transform on the variation in the encoder signal in one rotation of rotation stage 31 at each rotational speed in frequency analysis means 62, and a frequency component that does not change in the spectral intensity in the plurality (N) of measurements at different rotational speeds of rotation stage 31 is extracted and stored in storage means 63 as the fixed frequency component. N may be not less than two, and more preferably not less than five. Here, a frequency component having an intensity variation within ±10% at a plurality of different rotational speeds is regarded as “frequency component without intensity variation”.

Storage means 63 includes deflection correction amounts as a table for making correction on the deflection in order to compensate for a fixed frequency component at each predetermined radial position of a master placed on rotation stage 31 obtained by averaging fixed frequency components extracted by N measurements. Then, when pattern writing is performed, the deflection of the electron beam in a circumferential direction is corrected with respect to each predetermined radial position based on the table. By referencing to the table of frequency analysis means 62, a correction amount is inputted to compensation circuit 64 through drive control unit 40 and digital/analog converter DAC, and the correction amount is added to the deflection amount inputted from formatter 50 to deflection amplifier 28. The term “with respect to each predetermined radial position” may be every track or every plurality of tracks within a range in which the compensation error in the circumferential direction can be disregarded (e.g., every 8, 16, or 64 tracks, or the like).

In the mean time, it is difficult, in reality, to provide a table by measuring a variable frequency component other than the fixed frequency component of the encoder signal variation in advance for each writing rotational speed because it requires a huge amount of time and data capacity. Further, the variable frequency component is a component that reappears in the same rotational speed but changes in different rotational speeds, so that satisfactory compensation accuracy can not be obtained from the pre-measurements and use of average value. Therefore, the variable frequency component is measured and compensated for at the time of pattern writing. In reality, it is difficult to measure and compensate for an encoder signal variation for a radial position where writing is taking place. Here, the difference in the rotational speed between the target radial position and an adjacent radial position is very small, thus the variable frequency component of an encoder signal variation in the adjacent radial position does not deviate largely from that of the target radial position. Consequently, the variable frequency component is compensated for in the following manner. While pattern writing is performed in a specific radial position, a variation in the encoder signal at the specific radial position is measured by encoder signal variation measurement means 61. Then, frequency analysis of the encoder signal variation is performed by frequency analysis means 62, and a fixed frequency component is subtracted from the variation by referencing the table described above, whereby a variable frequency component is extracted. When writing for a next specific radial position next to the specific radial position is performed, a frequency correction amount determined based on the variable frequency component is inputted to clock frequency change unit 56 of write clock generation unit 52 of formatter 50. In this way, the clock frequency of the writing clock is changed by write clock generation unit 52 and the variable frequency component is compensated for.

A variation component may sometimes include an unsteady component which does not appear even measured repeatedly at the same rotational speed. Japanese Unexamined Patent Publication No. 2008-203555 cited under the “Description of the Related Art” proposes correction of an error due to such unsteady component by deflection, but the unsteady component is very small compared with the fixed frequency component or variable frequency component, which is reproducible in the same rotational speed but varies when the rotational speed is changed, to which the present invention is concerned, and the impact on the positional displacement of the pattern is also very small. Consequently, such unsteady components are deemed to be almost negligible in the present embodiment. On the other hand, Japanese Unexamined Patent Publication No. 2008-203555 does not describe correction of fixed frequency component (“scale error” in the specification) at all, and it is unclear how the scale error is corrected.

When performing writing at a radial position corresponding to an n^{th} track, a variation in the encoder signal in one rotation at the radial position is measured and the variation is subjected to a frequency analysis to subtract a fixed frequency component, whereby a variable frequency component is extracted. Then, when performing writing at a radial position corresponding to an n+1^{th} track, the clock frequency of the write clock is changed based on the variable frequency component extracted for the n^{th} track. Also, for the correction of variable frequency component, it is not necessarily to extract a variable frequency component for each track but every plurality of tracks (e.g., every 8, 16, or 64 tracks, or the like) and the write clock signal frequency for the next plurality of tracks may be changed using the variable frequency component.

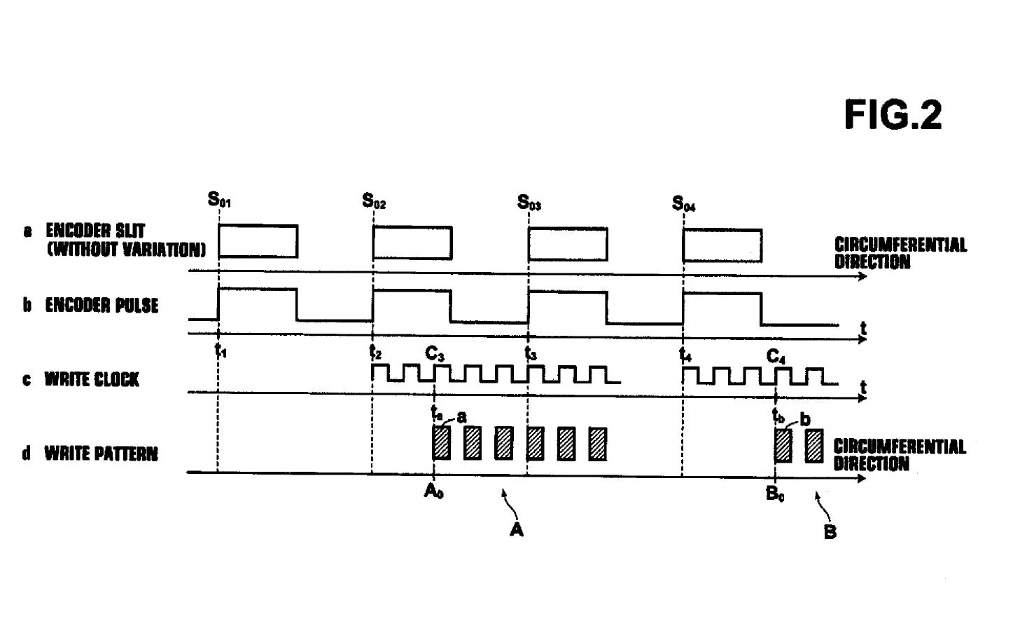

An encoder signal variation and a compensation method therefor will now be described with reference to FIGS. 2 to 4. Here, the description will be made on the assumption that the fixed frequency component of the encoder signal variation depends only on the shape variation of the encoder slits and the variable frequency component depends only on the rotational velocity variation removed of the shape variation of the encoder slits to facilitate understanding.

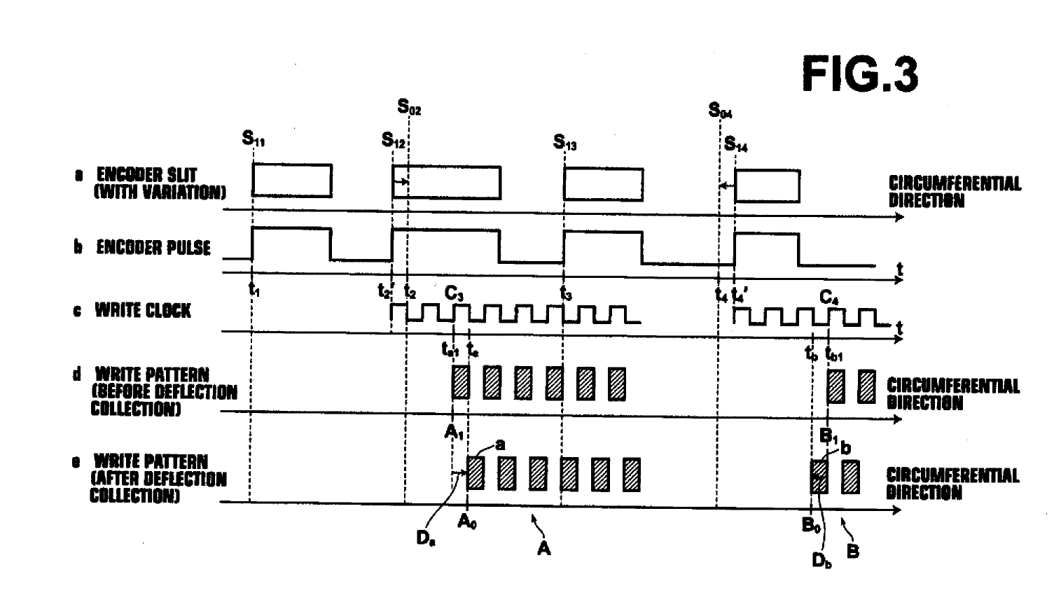

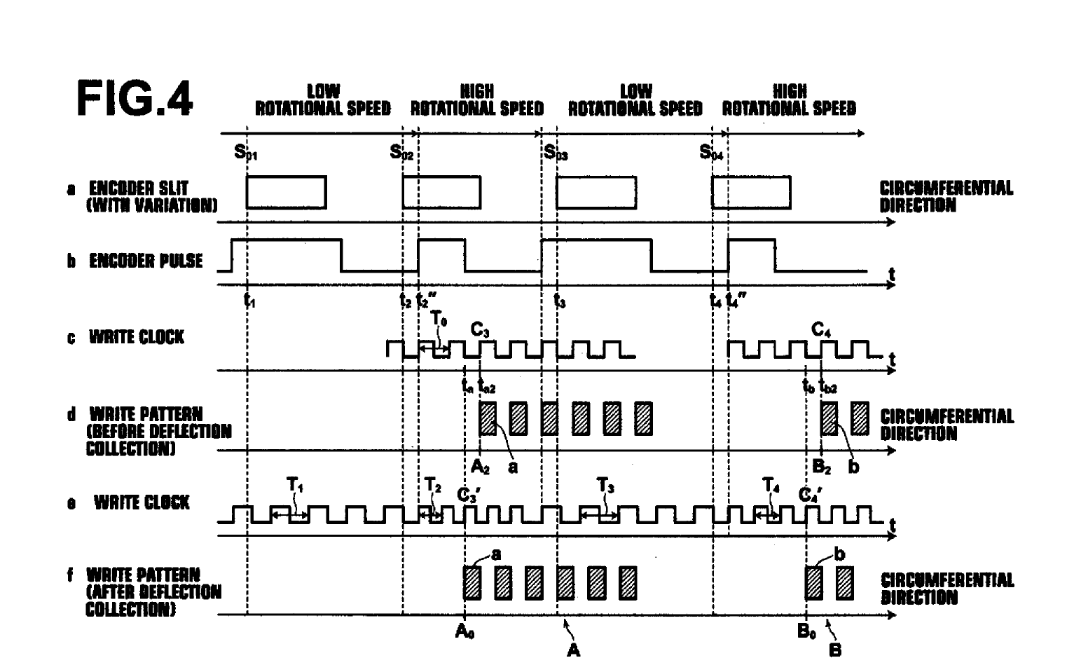

FIG. 2 schematically illustrates an ideal case without any encoder signal (encoder pulse) variation. FIG. 3 schematically illustrates a fixed frequency component of the encoder pulse variation and a compensation method therefor, and FIG. 4 schematically illustrates a variable frequency component of the encoder pulse variation and a compensation method therefor.

Referring now to FIG. 2, a illustrates the shapes of encoder slits formed in a circumferential direction of the rotating plate of the encoder, b illustrates an encoder pulse generated based on the shapes of the encoder slits of a, c illustrates a write clock, and d illustrates a write pattern written based on the encoder pulse of b and the write clock of c.

FIG. 2 illustrates an ideal case in which the encoder slits have no shape variation and the interval between each of slit positions S₀₁, S₀₂, S₀₃- - - is constant, and without any rotational velocity variation due to rotary drive motor and the like. If there is neither shape variation in the encoder slits nor any rotational velocity variation, the interval between each of generation times tᵢ, t₂, t₃, - - - of the encoder pulse is constant. The write start timings of the write patterns A and B are controlled such that the writing of the write pattern A is started at the time “ta” at which the write clock pulse C₃ occurs (pulse rising edge) which is the third write clock pulse from the time t₂ at which the encoder pulse nearest to the write start element “a” occurs (pulse rising edge), and the writing of the write pattern B is started at the time “tb” at which the write clock pulse C₄ occurs (pulse rising edge) which is the fourth write clock pulse from the time t₄ at which the encoder pulse nearest to the write start element “b” occurs (pulse rising edge). In this case, the write start positions Aₒ and Bₒ are arranged ideally.

Referring now to FIG. 3, a illustrates the shapes of encoder slits formed in a circumferential direction of the rotating plate of the encoder, b illustrates an encoder pulse generated based on the shapes of the encoder slits of a, c illustrates a write clock, d illustrates a write pattern written based on the encoder pulse of b and the write clock of c, and e illustrates a corrected write pattern corrected by adding an amount of deflection correction.

FIG. 3 illustrates a case in which the encoder slits have a shape variation but rotate at a constant speed without any rotational velocity variation. Here, unlike ideal encoder slit positions S₀₁, S₀₂, S₀₃- - - shown in a of FIG. 2, the encoder slits have a shape variation and some of the slits are shifted from the ideal positions, e.g., position S₁₁ corresponds to position S₀₁, position S₁₂ does not correspond to position S₀₂, position S₁₃ corresponds to position S₀₃, position S₁₄ does not correspond to position S₀₄, - - - , as shown in a of FIG. 3. Consequently, as shown in b of FIG. 3, the second and fourth encoder pulse occurrence times “t₂′” and “t₄′” are shifted from the encoder pulse occurrence times “t₂” and “t₄” of the ideal slit arrangement. Because the writing of the write pattern A is started at the time tₐ₁ at which the write clock pulse C₃ occurs which is the third write clock pulse from the time t₂′ at which the encoder pulse nearest to the write start element “a” occurs, the write position A₁ of the first element “a” is shifted ahead of the proper position A₀ in a circumferential direction, as shown in d of FIG. 3. Likewise, the writing of the write pattern B is started at the time t_{b1} at which the write clock pulse C₄ occurs which is the fourth write clock pulse from the time t₄′ at which the encoder pulse nearest to the write start element “b” occurs, so that the write position B₁ of the first element “b” is shifted behind the proper position B₀ in the circumferential direction.

Therefore, a deflection correction is performed for compensating for these displacements. As shown in e of FIG. 3, the correction is performed by adding deflection correction amounts Da and Db respectively in the circumferential direction so that, when writing based on the write clock C₃ is started, the write start position of the element “a” is moved back in the circumferential direction to position A₀ and, when writing based on the write clock C₄ is performed, the write start position of the element “b” is moved ahead in the circumferential direction to position Bₒ. In order to make adjustment to the deflection amounts, encoder pulse measurements and frequency analyses are performed in advance for a plurality of different rotational speeds to obtain fixed frequency components, whereby correction amounts are provided in a tabular format, as described above. For fixed frequency components, it may be possible to feed back the fixed frequency components measured in advance to design data and the design data are corrected based on the feedback in advance, instead of performing the deflection control.

Referring now to FIG. 4, a illustrates the shapes of encoder slits formed in a circumferential direction of the rotating plate of the encoder, b illustrates an encoder pulse generated based on the shapes of the encoder slits of a, c illustrates a write clock, d illustrates a write pattern written based on the encoder pulse of b and the write clock of c, e illustrates a write clock corrected according to the variable frequency component, and f illustrates a write pattern corrected based on the encoder pulse shown in b and the corrected write clock shown in e.

FIG. 4 illustrates a case in which the encoder silts do not have any shape variation and ideally arranged as in FIG. 2 but have a rotational velocity variation, in which first and third slits rotate slowly while second and fourth slits rotate quickly.

Even when the encoder slits are formed in an ideal shape, as illustrated in a of FIG. 4, the rotational velocity variation causes the encoder pulse occurrence times to be deviated from the ideal times t₁, t₂, t₃, t₄, - - - , as illustrated in b of FIG. 4. Here, the encoder pulse occurrence time t₂″, the basis of the write start position, comes after the ideal time t₂ and the encoder pulse occurrence time t₄″ comes before the ideal time t₄.

Accordingly, if writing is started using the write clock, shown in c of FIG. 4, having a period T₀ as in FIGS. 2 and 3, the write start position A₂ of the first element “a” of the pattern

A is shifted ahead of the proper write position Aₒ in the circumferential direction while the write start position B₂ of the first element “b” of the pattern B is shifted behind the proper write position B₀ in the circumferential direction, as shown in d of FIG. 4.

Therefore, the frequency (period) of the write clock is corrected to compensate for the shifting. That is, the frequency of the write clock is reduced (period is increased) at a low revolution speed portion while it is increased (period is reduced). As illustrated in e of FIG. 4, when writing the pattern A, the period T₂ is set such that the occurrence time of write clock pulse C₃′ which is the third pulse from the occurrence time t₂″ corresponds to the occurrence time t₀ of the third clock pulse from the occurrence time t₂ of the ideal encoder pulse having the period T₀. When writing the pattern B, the period T₄ is set such that the occurrence time of write clock pulse C₄′ which is the fourth pulse from the occurrence time t₄″ corresponds to the occurrence time t_{b} of the fourth clock pulse from the occurrence time t₄ of the ideal encoder pulse having the period T₀.

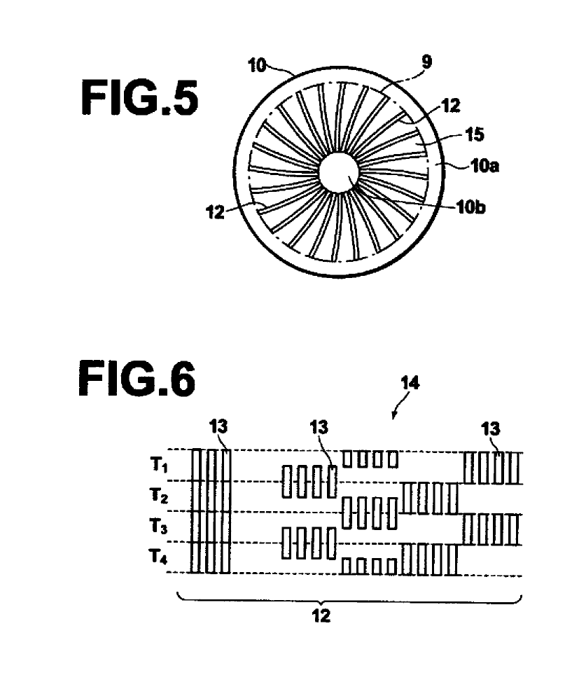

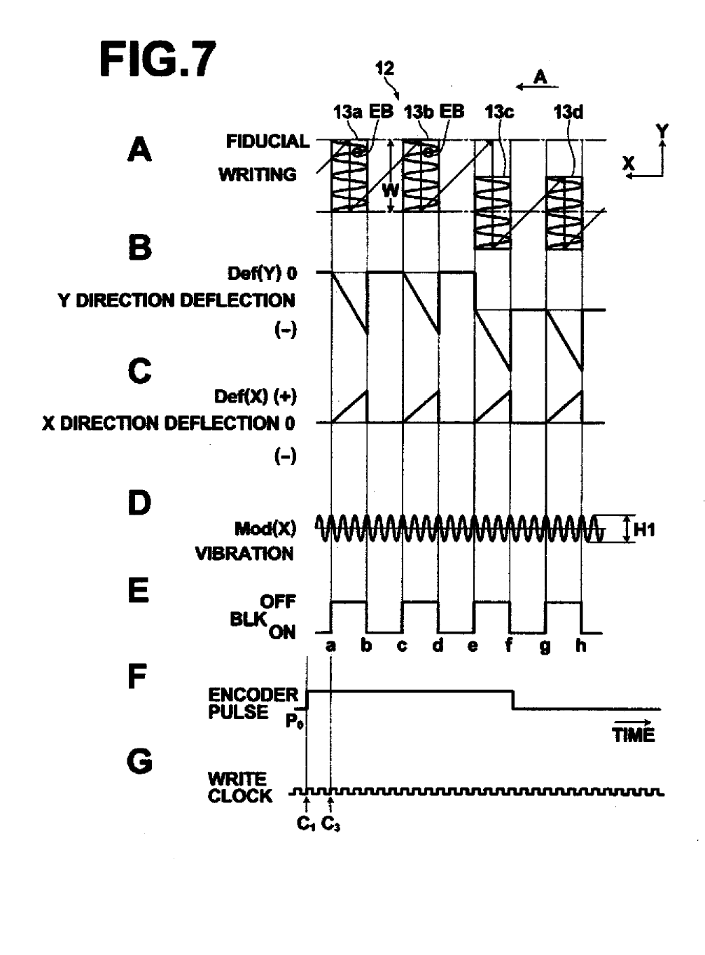

Next, a specific pattern writing method will be described. FIG. 5 is an overall plan view of a fine pattern for a magnetic recording medium (magnetic disk pattern) to be written on a substrate by an electron beam writing method of the present invention. FIG. 6 is a partially enlarged view of the fine pattern. FIG. 7 schematically illustrates, in an enlarged manner, a basic writing principle for writing elements of a fine pattern A and various signals B to G used in the basic writing principle shown in A.

As illustrated in FIGS. 5 and 6, fine pattern 9, for a magnetic disk medium formed of fine uneven shapes, includes servo areas 12 and data areas 15 alternately and regularly arranged in a circumferential direction and each servo area 12 has servo pattern 14. Fine pattern 9 is formed on an annular region of disk-shaped substrate 10 (circular substrate) excluding outer circumferential portion 10a and inner circumferential portion 10b. Servo patterns 14 are formed in elongated areas substantially radially extending from the center to each sector on concentric tracks of substrate 10 at regular intervals. Generally, each servo area 12 is formed in an arc shape extending in a radial direction, as illustrated in FIG. 5.

As shown in FIG. 6, which is an example of a partially enlarged view of servo pattern 14, fine rectangular servo elements corresponding to, for example, preamble, address, and burst signals are disposed on concentric tracks T1 to T4. One servo element 13 has a width of one track width and a track direction length greater than the electron beam diameter. Some of servo elements 13 of burst signals are shifted by a half track width and extending over the adjacent track.

The writing of servo elements 13 of servo patterns 14 are performed by placing substrate 10 applied with resist 11 on rotation stage 31 (FIG. 1), and while rotating substrate 10, sequentially scanning elements 13 with electron beam EB to scan expose resist 11 one track or a plurality of tracks at a time from a track on the inner circumferential side to a track on the outer circumferential side or vice versa.

FIG. 7 illustrates an embodiment of an electron beam writing method of the present invention. While substrate 10 is rotated unidirectionally in A direction, servo elements 13a to 13d are sequentially written at predetermined phase positions of concentric tracks (track width: W) which, when viewed microscopically, extend linearly in circumferential direction X orthogonal to radial direction Y by continuously scanning electron beam EB having a small diameter so as to completely fill the shapes of the elements.

The recording mode of servo patterns 12 described above is a constant angular velocity (CAV) mode, in which writing is performed such that the length of element 13 in the track direction is long on a track on the outer circumferential side and short on a track on the inner circumferential side according to the variation in the sector length between the inner and outer circumferences.

The scanning of electron beam EB is performed in the following manner. That is, while electron beam EB having a smaller beam diameter than a minimum track direction length of servo elements 13a to 13d is emitted through ON/OFF operation of blanking means 24, to be described later, according to the writing area, electron beam EB is deflected in a radial direction Y and a direction orthogonal to the radial direction Y (circumferential direction X) and rapidly vibrated back and forth in circumferential direction X orthogonal to the radial direction Y at a constant amplitude according to the rotational speed of substrate 10 (rotation stage 41) as shown in (A) of FIG. 7. In this way, electron beam EB is scanned so as to completely fill servo elements 13a and 13b, whereby the elements 13a and 13b are written. Following the writing of in-track servo elements 13a and 13b, the writing fiducial is shifted in radial direction Y by a half track width and writing of servo elements 13c and 13d extending over the adjacent track is performed in the same manner as described above.

The writing of servo elements 13a to 13d will be described sequentially. A of FIG. 7 illustrates the writing operation of electron beam EB in radial direction Y and circumferential direction X (rotational direction), B illustrates deflection signal Def(Y) in radial direction Y, C illustrates deflection signal Def(X) in circumferential direction X, D illustrates vibration signal Mod(X) in circumferential direction X, E illustrates ON/OFF operation of blanking signal BLK, F illustrates an encoder pulse, and G illustrates a write clock. The horizontal axis in B to G of FIG. 7 represents time “t” (rotation angle).

The write clock signal of G is generated in formatter 50 based on a constant basic clock signal which does not vary under any circumstances. The write clock signal is controlled, based on the basic clock signal, according to the variation in the rotational speed V of the rotation stage 31 such that, even when the rotational speed of the rotation stage 31 is different between a time when an inner track is written and a time when an outer track is written, such that the number of clocks per revolution (one circumference) of rotation stage 31 remains the same.

First, at point “a”, the blanking signal BLK E is turned ON to emit electron beam EB, whereby writing of servo element 13a is started. While being vibrated back and forth in circumferential direction X by vibration signal Mod(X) D, electron beam. EB at the fiducial position is deflected by deflection signal Def(Y) B and moved in radial direction (−Y), and at the same time deflected and moved in circumferential direction X which is the same direction as A direction by deflection signal Def (X) C in order to compensate for displacement of the emission position of electron beam EB arising from the rotation of substrate 10 in A direction, whereby electron beam EB is scanned so as to completely fill the rectangular servo element 13a. Then, at point “b”, blanking signal BLK is turned OFF to terminate the emission of electron beam. EB, whereby the writing of the servo element 13a is completed. After point “b”, the deflections in radial direction Y and circumferential direction X are returned to the fiducial position.

Then, when substrate 10 is rotated further and reaches point “c”, the writing of servo element 13b is started in the same manner as described above, and the writing is performed in the same manner based on the similar deflection signal and the writing of servo element 13b is completed at point “d”.

At point “e”, the fiducial position of the deflection signal Def(Y) shown in B is shifted by a half track width in the radial direction (−Y), and the electron beam EB is deflected by deflection signal Def (Y) B and moved in radial direction (−Y), and at the same time deflected and moved in circumferential direction X which is the same direction as A direction by deflection signal Def (X) C from the fiducial position while being vibrated back and forth in circumferential direction X by vibration signal Mod(X) D in the same manner as described above, whereby electron beam EB is scanned so as to completely fill the rectangular servo element 13c. Then, at point “f”, blanking signal BLK is turned OFF to terminate the emission of electron beam EB, whereby the writing of the servo element 13c is completed. After point “f”, the deflections in radial direction Y and circumferential direction X are returned to the fiducial position.

When substrate 10 is rotated further and reaches point “g”, the writing of servo element 13d is started in the same manner as described above, and the writing is performed in the same manner based on the similar deflection signal and the writing of servo element 13d is completed at point “h”.

Note that when writing servo elements 13, accurate positioning is performed at a plurality of writing start points, such as point “a” shown in E of FIG. 7 and the like, based on the encoder pulse signal shown in F of FIG. 7 to improve accuracy of the forming position of the servo patterns 13 in one round. Here, the control is performed such that the writing is started in synchronization with the occurrence time of write clock pulse C₃ which is the third pulse from encoder pulse occurrence time P₀. In the present embodiment, time P₀ corresponds to the occurrence time of write clock pulse C₁, but even when they do not correspond to each other, the writing is started from the occurrence time of third write clock pulse from time P₀.

After writing one track for one round is completed, the writing is performed for the next track in the same manner as described above, whereby a desired fine pattern 9 is written over the entire writing area of substrate 10. The track migration of writing position (in radial direction) is performed by deflecting electron beam EB in radial direction Y or by linearly moving rotation stage 31, to be described later, in radial direction Y. The linear movement of the rotation stage 31 for writing may be performed for every plurality of tracks according to the deflectable range of electron beam EB in radial direction Y or for each track. It is more efficient to shift electron beam EB in radial direction by the deflection means. Therefore, it is preferable to shift electron beam EB within the deflectable range of electron beam EB to write for a plurality of tracks (8 tracks, 16 tracks, 64 tracks, or the like), then to release the deflection operation by the beam deflection means temporarily and move the rotation stage 31 in the radial direction by linear moving means 34 for a plurality of tracks.

The write length (corresponding to bit length) of servo elements 13 in circumferential direction X is defined by the amplitude of the back and forth vibration of electron beam EB in the circumferential direction X.

It is preferable that the writing is performed by controlling the rotation of the rotation stage 31 such that the rotational speed becomes faster at an inner circumferential track and slower at an outer circumferential track so that substrate 10 is rotated in the same linear speed over the entire writing area including inner and outer circumferential portions, thereby ensuring the uniform exposure and accuracy of writing position.

Deflection signal Def(X) in circumferential direction X allows writing of any parallelogram element by adjusting the magnitude, as well as compensation for the displacement of writing position arising from the rotation of rotation stage 31 when writing a rectangular element shown in FIG. 7.

The beam intensity of electron beam EB is set to a value that allows resist 11 to be sufficiently exposed by the rapid vibration writing of servo elements 13 described above. That is, the writing width (real exposure width) tends to become wider than the irradiation beam diameter and amplitude according to the exposure time and amplitude. Therefore, the amplitude and deflection speed of electron beam EB are controlled so as to be scanned with a predetermined radiation dose corresponding to the writing width. Note that it is difficult to change beam intensity in the middle of writing from the viewpoint of beam stability.

As described above, the timing of the pattern writing is controlled based on the encoder pulse and write clock signal. Therefore, if the encoder pulse varies, the arrangement accuracy of the pattern in the circumferential direction becomes unsatisfactory. Meanwhile, it is unrealistic to add a correction amount corresponding to the fixed frequency component of an encoder pulse variation described above or to change the write clock. Consequently, the deflection correction and variation correction based on the write clock frequency change are performed on the write position of the element in a servo pattern to be written first in servo areas disposed regularly.

In the embodiment described above, the description has been made of a case, as the writing method, in which each fine element is written by deflecting an electron beam in a radial direction while vibrating rapidly in a circumferential direction to completely fill the element. But, the writing method of the present invention may be applied to a conventional ON/OFF writing method or a writing method in which the electron beam is rapidly vibrated in a radial direction for timing control of write start position (pattern arrangement in circumferential direction) with respect to each position in the radial direction of each servo area or data area, whereby the identical positioning accuracy, i.e., an advantageous effect of improving the pattern arrangement accuracy in the circumferential direction may be obtained.

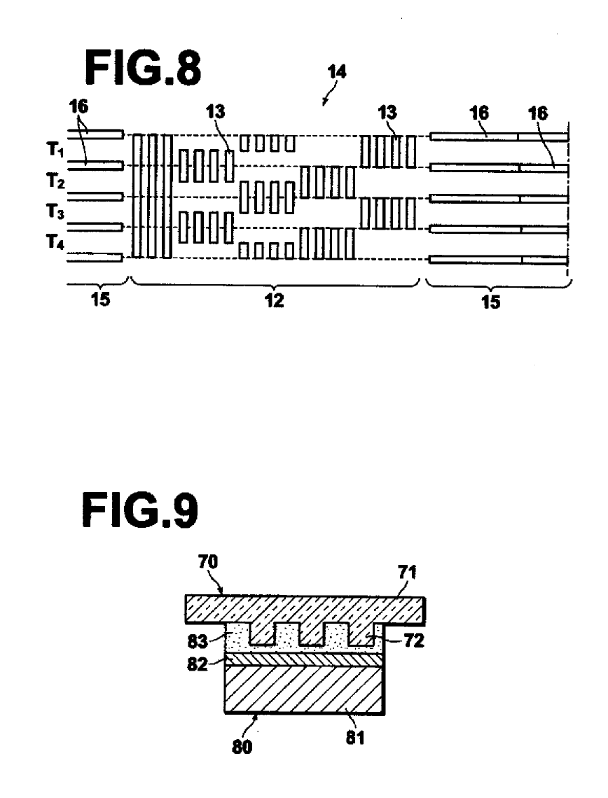

For a discrete track medium, which has received attention in recent years, groove patterns 16 extending in a track direction are concentrically formed in a guard band section between each data track in data areas 15 so as to separate each of adjacent tracks T1 to T4 by the grooves, in addition to servo pattern 14 formed in servo area 12 like that described above, as shown in FIG. 8 which is a partially enlarged view of a hard disk pattern. The groove patterns are written by separate write control. Servo area 12 is formed in an arc shape extending from the radial center to outside and the data area 15, in which groove pattern 16 is provided, formed between the servo areas 12 is also shaped in an arc extending from the radial center to outside, so that the write start point of groove pattern 16 at each radial position (each track) may be determined accurately by compensating for any encoder pulse variation through an electron beam deflection control in the circumferential direction and a write clock signal frequency control as in the timing control of the pattern writing in the servo area described above.

### <Uneven Pattern Carrier Manufacturing Method and Magnetic Disk Medium Manufacturing Method>

A method for manufacturing an imprint mold, which is an uneven pattern carrier, to be manufactured through a process of writing a fine pattern by the electron beam writing method described above using the electron beam writing apparatus described above and a method for manufacturing a magnetic disk medium using the imprint mold will now be described. FIG. 9 is a schematic cross-sectional view of the imprint mold and magnetic disk medium, illustrating one process in which a fine uneven pattern is transfer formed from the imprint mold to the magnetic disk medium.

The method for manufacturing imprint mold 70 will be described first. Resist 11 not shown in FIG. 9 is applied on a surface of substrate 71 made of a transparent material and servo patterns 12 and groove patterns are written thereon. Thereafter, resist 11 is processed to form an uneven pattern of the resist on substrate 71. Substrate 71 is etched with the patterned resist as the mask, and then the resist is removed, whereby imprint mold 70 having fine uneven pattern 72 formed thereon is obtained. As an example, fine uneven pattern 72 includes servo patterns and groove patterns for a discrete track medium.

Next, a method for manufacturing a magnetic disk medium by imprint method using imprint mold 70 will be described. Magnetic disk medium 80 includes substrate 81 on which magnetic layer 82 is stacked and resist resin layer 83 for forming a mask layer is provided thereon. The uneven shape of fine uneven pattern 72 is transfer formed by pressing fine uneven pattern 72 of imprint mold 70 against resist resin layer 83 and solidifying resist resin layer 83 by ultraviolet radiation. Thereafter, magnetic layer 82 is etched based on the uneven shape of resist resin layer 83 to form magnetic disk medium 80 of discrete track medium with the fine uneven pattern formed on magnetic layer 82.

The above description is a manufacturing process of a discrete track medium, but a bit pattern medium may also be manufactured through an identical process.

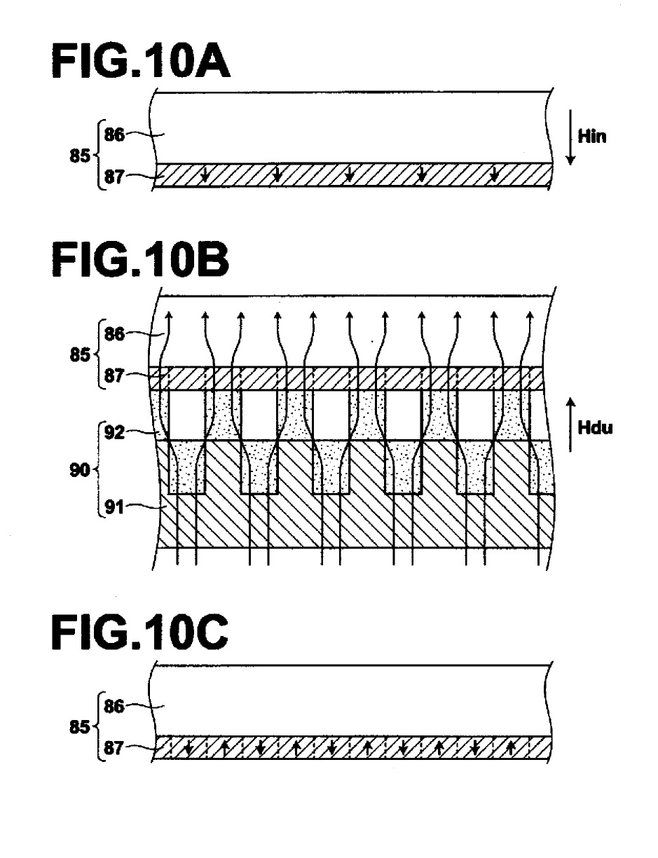

A method for manufacturing a magnetic transfer master carrier (uneven pattern carrier) to be manufactured through a process in which a fine uneven pattern is written by the electron beam writhing method described above using electron beam writing apparatus 100 like that described above will be described. FIG. 10 is a schematic cross-sectional view of magnetic transfer master carrier 90 and magnetic disk medium 85, illustrating a process in which a magnetic pattern is magnetically transferred from master carrier 90 to magnetic disk medium 85.

The manufacturing process of magnetic transfer master carrier 90 is substantially identical to that of imprint mold 70. Substrate 10 to be placed on rotation stage 31 is made of, for example, a silicon, glass, or quartz disk, and positive or negative electron beam writing resist 11 is applied thereon. Then resist 11 is scanned with an electron beam to write a desired pattern thereon. Thereafter, resist 11 is processed to obtain substrate 10 having an uneven pattern of the resist, which is a master of magnetic transfer master carrier 90.

Next, a thin conductive layer is formed on the surface of the uneven pattern formed on the surface of the master, and electroforming is performed thereon to obtain substrate 91 having an uneven pattern of metal casting. Thereafter, substrate 91 having a predetermined thickness is peeled off from the master. The uneven pattern on the surface of substrate 91 is a reverse pattern of the uneven shape of the master.

After grinding the rear surface of substrate 91, magnetic layer 92 (soft magnetic layer) is stacked on the uneven pattern to obtain magnetic transfer master carrier 90. The shape of convex portion or concave portion of the uneven pattern on the surface of substrate 91 depends on the uneven pattern of the resist of the master.

A magnetic transfer method using magnetic transfer master carrier 90 manufactured in the manner as described above will now be described. Magnetic disk medium 85 which is a medium to which information is transferred is, for example, a hard disk, flexible disk, or the like which includes substrate 86 having magnetic recording layer 87 formed on either one of the sides or on both sides. Here, it is assumed to be a perpendicular magnetic recording medium in which the easy direction of magnetization of magnetic recording layer 87 is perpendicular to the recording surface.

As shown in FIG. 10A, initial DC field Hin is applied to magnetic disk medium 85 in a direction perpendicular to the track surface in advance to initially DC-magnetize magnetic recording layer 87. Thereafter, as shown in FIG. 10B, magnetic transfer is performed by bringing the surface of magnetic disk medium 85 on the side of recoding layer 87 into close contact with the surface of master carrier 90 on the side of magnetic layer 92 and applying transfer field Hdu in a direction perpendicular to the track surface of magnetic disk medium 85 and opposite to the direction of initial DC field Hin. As the result the transfer field is drawn into magnetic layer 92 of master carrier 90 and the magnetization of magnetic layer 87 of magnetic recording medium 85 at the portions corresponding to the convex portions of magnetic layer 92 of master carrier 90 is reversed, as shown in FIG. 10C, while the magnetization of the other portions is not reversed. Consequently, information (e.g., servo signal) corresponding to the uneven pattern of master carrier 90 is magnetically transfer recorded on magnetic recording layer 87 of magnetic disk medium 85. Note that, when performing magnetic transfer also to the upper side recording layer of magnetic disk medium 85, the magnetic transfer is performed at the same time with the magnetic transfer of the lower side recording layer by bringing the upper side recording layer and an upper side master carrier into close contact with each other.

In the case of magnetic transfer to a longitudinal magnetic recording medium, master carrier 90 which is substantially the same as that used for the vertical magnetic recording medium is used. For the longitudinal recording medium, the magnetic disk medium is DC-magnetized along a track direction in advance. Then magnetic transfer is performed by bringing the magnetic disk medium into close contact with the master carrier and applying a transfer field in the direction opposite to that of the initial DC magnetization. The transfer magnetic field is drawn into convex portions of the magnetic layer of the master carrier 90 resulting in that the magnetization of the portions of the magnetic layer of the magnetic disk medium corresponding to the convex portions is not reversed while the magnetization of the other portions is reversed. In this way, a magnetic pattern corresponding to the uneven pattern may be recorded on the magnetic disk medium.

The above described manufacturing method of the imprint mold or magnetic transfer master carrier using the electron beam writing method of the present invention is illustrative only. The method is not limited to this and any method may be used as long as it has a process of writing a fine pattern to form an uneven pattern using the electron beam writing method of the present invention.

What is claimed is:

1. An electron beam writing method that performs pattern writing on a master placed on a rotation stage having an encoder and rotated by the rotation stage by emitting an electron beam to the master based on a predetermined write clock,
wherein, when performing the pattern writing, a fixed frequency component, which is a component of a variation in an encoder signal from the encoder in one rotation of the rotation stage that commonly appears in a plurality of different rotational speeds of the rotation stage, is compensated for by deflection correcting the electron beam in a circumferential direction, and a variable frequency component, which is a component of the variation in the encoder signal other than the fixed frequency component, is compensated for by changing the clock frequency of the write clock.

2. The electron beam writing method of claim 1, wherein:
the fixed frequency component is obtained and stored in advance by measuring a variation in the encoder signal in one rotation of the rotation stage a plurality of times by changing the rotation speed of the rotation stage, performing a frequency analysis on each variation in the encoder signal, and extracting the fixed frequency component from frequency components of the variation in the encoder signal; and
when performing the pattern writing, the electron beam is deflection corrected in the circumferential direction with respect to each predetermined radial position of the master based on the fixed frequency component in one rotation of the rotation stage.

3. The electron beam writing method of claim 1, wherein:
the fixed frequency component is obtained and stored in advance by measuring a variation in the encoder signal in one rotation of the rotation stage a plurality of times by changing the rotation speed of the rotation stage, performing a frequency analysis on each variation in the encoder signal, and extracting the fixed frequency component from frequency components of the variation in the encoder signal; and
the variable frequency component is extracted by measuring a variation in the encoder signal from the encoder in one rotation of the rotation stage at each predetermined radial position of the master, performing a frequency analysis on the variation in the encoder signal, and subtracting the fixed frequency component from the variation, and the clock frequency of the write clock is changed for writing in one rotation of the rotation stage at a next predetermined radial position of the master after the predetermined radial position based on the variable frequency component.

4. The electron beam writing method of claim 1, wherein:
a magnetic disk pattern having servo patterns disposed regularly in the circumferential direction is written in the pattern writing; and
the variation of the encoder signal is compensated for with respect to each start position of the servo patterns in each round of the rotation stage.

5. An electron beam writing apparatus that performs pattern writing on a master placed on a rotation stage having an encoder and rotated by the rotation stage by emitting an electron beam to the master based on a predetermined write clock, the apparatus comprising:
a variation measurement means for measuring a variation in an encoder signal from the encoder in one rotation of the rotation stage;
a frequency analysis means for performing a frequency analysis on the variation in the encoder signal measured by the variation measurement means;
a deflection correction means for deflection correcting the electron beam in a circumferential direction such that a fixed frequency component, which is a component of the variation in the encoder signal that commonly appears in a plurality of different rotational speeds, is compensated for; and
a clock frequency correction means for changing the clock frequency of the write clock such that a variable frequency component, which is a component of the variation in the encoder signal other than the fixed frequency component, is compensated for.

6. The electron beam writing apparatus of claim 5, wherein:
the apparatus further comprises a storage means for storing the fixed frequency component of frequency components of the variation in the encoder signal measured in advance by the variation measurement means and frequency analyzed by the frequency analysis means; and
when the pattern writing is performed, the deflection correction means deflection corrects the electron beam in the circumferential direction with respect to each predetermined radial position of the master based on the fixed frequency component in one rotation of the rotation stage.

7. The electron beam writing apparatus of claim 5, wherein:
the apparatus further comprises a storage means for storing the fixed frequency component of frequency components of the variation in the encoder signal measured in advance by the variation measurement means and frequency analyzed by the frequency analysis means;
the variation measurement means is a means that measures a variation in the encoder signal from the encoder in one rotation of the rotation stage with respect to each predetermined radial position of the master;
the frequency analysis means is a means that performs a frequency analysis on the variation in the encoder signal; and
the clock frequency correction means is a means that extracts the variable frequency component by subtracting the fixed frequency component from the variation, and changes the clock frequency of the write clock for writing in one rotation of the rotation stage at a next predetermined radial position after the predetermined radial position based on the variable frequency component.

8. An uneven pattern carrier manufacturing method, comprising the steps of:
writing a desired fine pattern on a master by an electron beam writing method; and
forming an uneven pattern corresponding to the desired fine pattern using the master,
wherein the electron beam writing method performs pattern writing on the master placed on a rotation stage having an encoder and rotated by the rotation stage by emitting an electron beam to the master, wherein, when performing the pattern writing, a fixed frequency component, which is a component of a variation in an encoder signal from the encoder in one rotation of the rotation stage that commonly appears in a plurality of different rotational speeds of the rotation stage, is compensated for by deflection correcting the electron beam in a circumferential direction, and a variable frequency component, which is a component of the variation in the encoder signal other than the fixed frequency component, is compensated for by changing the clock frequency of the write clock.
